(19) United States
(12) Patent Application Publication
(10) Pub. No.: US 2026/0229974 A1
(43) Pub. Date: Aug. 6, 2026

(54) ROTOR AND ELECTRIC MACHINE

(71) Applicant: Schaeffler Technologies AG & Co. KG, Herzogenaurach (DE)

(72) Inventors: Jean-Francois Heller, Strassburg (FR); Martin Häßler, Graben-Neudorf (DE); Alain Rusch, Gambsheim (FR); László Sarkadi, Szombathely (HU)

(73) Assignee: Schaeffler Technologies AG & Co. KG, Herzogenaurach (DE)

(21) Appl. No.: 19/151,992

(22) PCT Filed: Dec. 8, 2023
(86) PCT No.: PCT/DE2023/100952

§ 371 Date: Jul. 29, 2025

(30) Foreign Application Priority Data
Jan. 30, 2023 (DE) 10 2023 102 105.2

(51) Int. Cl. H02K 21/02

(52) U.S. Cl. CPC H02K 21/024

(57) ABSTRACT

A rotor is disclosed which has first and second rotor bodies with first and second groups of permanent magnets, respectively, wherein the first and second rotor bodies are rotated relative to each other about a common rotational axis against an effect of a torsional stiffness mechanism by a field-attenuation mechanism. The field-attenuation mechanism includes a first lever element pivoted about a fulcrum. The first and second rotor bodies are coupled to first and second lever sections, respectively, of the lever element. The lever sections are arranged on opposite sides of the lever relative to a circumferential direction so that by tilting the lever element, the first and second rotor bodies are rotated relative to each other to adjust the field-attenuation mechanism. Coaxially within the rotor bodies, a rotor shaft is torque-transmittingly coupled to the rotor bodies by the lever element. The lever element is pivotably mounted on the rotor shaft.

### CROSS-REFERENCE TO RELATED APPLICATIONS

This application is a U.S. National Stage Application of Patent Cooperation Treaty (PCT) Application No. PCT/DE 2023/100952 filed Dec. 8, 2023, which claims priority to German Patent Application 10 2023 102 105.2, filed Jan. 30, 2023.The content of these applications is incorporated by reference herein in their entireties.

### FIELD OF INVENTION

The present invention relates to a rotor for an electric machine, in particular for use within a drivetrain of a hybrid or fully electrically driven motor vehicle, wherein the rotor has at least one first rotor body with a first group of permanent magnets and a second rotor body with a second group of permanent magnets, wherein the first rotor body and the second rotor body can be rotated relative to each other about a common rotational axis against the effect of a first torsional stiffness mechanism by means of a mechanical field-attenuation mechanism, the field-attenuation mechanism includes a first lever element which can be pivoted about a fulcrum, wherein the first rotor body can be coupled to a first lever section and the second rotor body can be coupled to a second lever section of the lever element, and the first lever section and the second lever section are arranged on opposite sides of the lever element relative to a circumferential direction so that, by tilting the lever element, the first rotor body and the second rotor body can be deliberately rotated relative to each other in order to produce a desired adjustment of the mechanical field-attenuation mechanism, wherein, coaxially within the first rotor body and the second rotor body, a rotor shaft can be torque-transmittingly coupled to the first rotor body and the second rotor body by means of the lever element. The invention further relates to an electric machine.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort to which they are accustomed.

A detailed description of an electric drive can be found in an article in the German automotive magazine ATZ, volume 113, 05/2011, pages 360-365 by Erik Schneider, Frank Fickl, Bernd Cebulski and Jens Liebold with the title: “Hochintegrativ und flexibel-Elektrische Antriebseinheit für E-Fahrzeuge” [Highly Integrative and Flexible-Electric Drive Unit for Electric Vehicles], which may be the closest prior art.

This article describes a drive unit for an axle of a vehicle which includes an electric motor arranged to be coaxial with respect to a bevel gear differential. Such drive units are also referred to as e-axles or electrically operable drivetrains.

Electric machines are subject to losses during operation due to magnetic reversal, which are grouped together as iron losses and reduce the machine efficiency. In mobile applications, low efficiency of the electric machine means a reduced range of the vehicle or increased demand for battery capacity. It is therefore an ongoing goal, especially in mobile applications with purely electric drive, to minimize the iron losses described.

An example of such an electric machine with iron losses, as can be used within a drivetrain of a hybrid or fully electrically driven motor vehicle, is what is termed the permanently excited synchronous machine. Due to its high power density compared to other types of machines, it may be for use in the field of electromobility, where the available installation space is often a limiting factor. The excitation field of the machine is usually generated by permanent magnets that are arranged in the rotor of the machine. In a permanently excited synchronous machine, it is possible to dispense with a slipring contact which is necessary in electrically excited synchronous machines to supply power to an excitation coil arranged on the rotor.

However, a disadvantage of permanent excitation is that the excitation field cannot be easily modified. In principle, a synchronous machine can be operated beyond its rated speed by controlling what is termed the field-attenuation range. In this range, the machine is operated at its maximum rated power, with the torque delivered by the machine decreasing as the rotational speed increases. Electrically excited synchronous machines can be operated very easily in the field-attenuation range by reducing the excitation current. Even in the case of permanent magnet machines, there are known ways of generating an air gap field component by means of a suitable current supply to the stator of the machine, which counteracts the excitation field generated by the permanent magnets and thus weakens it. However, such control of the machine causes increased losses, so the machine can only be operated with a reduced efficiency in this range.

An effective method for reducing iron losses in electrical machines is to deliberately weaken the magnetic field between stator and rotor for operating points with high rotational speeds, since the losses due to high-frequency magnetic reversal are lower with a weaker magnetic field. In addition to electrical approaches, there are also mechanical approaches for targeted field attenuation. Patent documents U.S. Pat. No. 5,821,1710, FR2831345, EP1085644, EP11867030, DE1012011708670, DE1012016103470, CN104600929 and CN105449969 disclose a rotor of a radial flux machine which is divided in a manner perpendicular to the rotational axis into plurality of rotor disks which are equipped with permanent magnets and which can be rotated relative to one another. Depending on the relative rotation between the rotor disks, the rotor provides the full magnetic field in a position with the magnetic poles axially aligned and a weakened magnetic field in a position rotated relative to this. Active or passive mechanisms are described which claim to be able to switch between these two positions according to the rotor speed or torque and thus enable more efficient operation of the electric machine over the entire motor characteristic map.

DE 10 12021 101 898 describes an arrangement in which the rotor of a radial flux machine is divided into two rotor sections, the individual rotor disks of which alternate in the axial direction. One part of the rotor is connected directly and the other part of the rotor is connected via a torsional stiffness mechanism to the rotor shaft for rotation in a torque-transmitting manner. The torsional stiffness mechanism is selected in such a way that at low torque the rotor sections are in a rotational position with a weakened magnetic field and at high torque the rotor sections are in a rotational position with a full magnetic field. DE 10 12021 101 904 claims a structurally designed mechanical module that can be introduced into the interior of the rotor disks equipped with permanent magnets, creates the described connections of the rotor sections to the rotor shaft and allows an adjustment characteristic curve to be defined via the torsional stiffness mechanism, which is implemented with springs and roller-equipped cam mechanisms.

All previously mentioned passive solutions, which use a torque as a sensor variable to trigger a relative rotation between two rotor sections against a torsional stiffness mechanism, assume that the total electromagnetic torque generated by the stator current supply in the case of the initially field-weakened position with non-aligned magnetic poles is simply distributed between the two rotor sections, approximately according to their share of the total length and according to their respective phase positions with respect to the stator field, regardless of the presence of the other rotor section. Only then could a partial torque proportional to the total torque be easily directed against a torsional stiffness mechanism between the rotor sections or one of the rotor sections and the rotor shaft and bring about the desired rotation with increasing torque into the position with a full magnetic field with aligned magnetic poles. However, tests and modeling by the applicant have shown that the actual situation is far more complicated.

Even in the de-energized case, there are interactions between the rotor discs of the two parts of the rotor in the form of magnetic repulsion moments. The position with a full magnetic field and aligned magnetic poles represents a labile equilibrium with vanishing repulsion torque. As the rotation begins from this equilibrium position, a repulsion torque arises which increases with increasing rotation until it reaches a maximum and then decreases again with further rotation. The course of the repulsion torque over the angle of rotation within an electrical period, the height of the maximum, and the angle of rotation at which it occurs depend strongly on the chosen type of arrangement of the permanent magnets within the rotor disks. The course over an electrical period is fundamentally nonlinear.

In the case of the desired efficient stator current supply for different rotational speeds, these magnetic repulsion torques increase in different ways, sometimes several times, depending on the rotational speed. Overall, partial torques result which are not suitable, in any case, to be easily directed against a torsional stiffness mechanism between the rotor sections or one of the rotor sections and the rotor shaft in order to cause a rotation of the rotor sections into the position with a full magnetic field, since they do not point in the right direction for this due to the high proportion of magnetic repulsion torques.

For reliable adjustment behavior, it is necessary, among other things, that the adjustment characteristic curve of the mechanical field attenuation over the motor characteristic map neither changes undesirably nor has any excessive hysteresis. At the rotational speeds of today's traction machines in the automotive sector, however, the effect of centrifugal force, in particular on the existing torsional stiffness mechanisms, which can be designed as compression springs, for example, results in an undesirably high shift of the adjustment characteristic curve towards higher torques. Increasing friction on guide elements of the torsional stiffness mechanism can also lead to excessive hysteresis in the adjustment characteristic curve.

### SUMMARY

In order to provide a functional arrangement in the sense of the aforementioned passive solutions for torque-adaptive field attenuation of the rotor of an electrical machine, an object of the present disclosure is to provide an electric machine with improved mechanical field attenuation.

The object is addressed by a rotor for an electric machine, in particular for use within a drivetrain of a hybrid or fully electrically driven motor vehicle, wherein the rotor has at least one first rotor body with a first group of permanent magnets and a second rotor body with a second group of permanent magnets, wherein the first rotor body and the second rotor body can be rotated relative to each other about a common rotational axis against the effect of a first torsional stiffness mechanism by means of a mechanical field-attenuation mechanism, the field-attenuation mechanism includes a first lever element which can be pivoted about a fulcrum, wherein the first rotor body can be coupled to a first lever section and the second rotor body can be coupled to a second lever section of the lever element, and the first lever section and the second lever section are arranged on opposite sides of the lever element relative to a circumferential direction so that, by tilting the lever element, the first rotor body and the second rotor body can be deliberately rotated relative to each other in order to produce a desired adjustment of the mechanical field-attenuation mechanism, wherein, coaxially within the first rotor body and the second rotor body, a rotor shaft can be torque-transmittingly coupled to the first rotor body and the second rotor body by means of the lever element, the lever element is pivotably mounted on the rotor shaft.

This provides the advantage that an electric machine can be realized with a purely mechanical field-attenuation device, which reliably and cost-effectively adjusts the positions of permanent magnets within the rotor which are required for needs-based field attenuation according to the operating states of torque and speed. In principle, the present disclosure thus also avoids the need for actuators to intervene on or in the rotor from the outside.

The electric machine can in particular be designed as a rotary machine. In the case of electric machines designed as rotary machines, a distinction is drawn in particular between radial flux machines and axial flux machines. A radial flux machine is characterized in that the magnetic field lines extend radially in the air gap formed between the rotor and the stator, while in the case of an axial flux machine the magnetic field lines extend axially in the air gap formed between the rotor and the stator. In the context of the present disclosure, it is possible for the electric machine to be configured as a radial flux machine or axial flux machine.

A rotor is the rotating (spinning) part of an electric machine. The rotor in particular includes a rotor shaft and one or more rotor bodies formed of rotor lamination stacks which are arranged on the rotor shaft in a rotationally fixed manner. The rotor shaft can be hollow, which, on the one hand, results in weight savings and, on the other hand, allows the supply of lubricant or coolant to the rotor body.

A rotor body for the purposes of the present disclosure is understood to mean the rotor without a rotor shaft. The rotor body is therefore made in particular of a rotor lamination stack and the permanent magnets inserted into the pockets of the rotor lamination stack or fixed to the circumference of the rotor lamination stack, as well as any axial cover parts for closing the pockets.

The permanent magnets may be inserted into the pockets of the rotor lamination stack. A single larger rotor magnet designed as a bar magnet or a plurality of smaller rotor magnets designed as permanent magnet elements can be provided for each pocket.

The rotor has a plurality of rotor bodies. Particularly, the rotor bodies are formed substantially the same, in particular substantially identically. It is highly possible that the rotor bodies are formed from the same, in particular substantially identical rotor laminations. The rotor bodies are therefore particularly formed from a rotor lamination stack which is composed of a plurality of laminated individual sheets or rotor laminations, usually made of electrical steel, which are layered and stacked one above the other to form a stack, that which is referred to as the rotor lamination stack. The individual sheets can be held together in the rotor lamination stack by adhesive bonding, welding, or screwing. A rotor lamination stack can in particular also have permanent magnets that are inserted into the pockets of the rotor lamination stack, or that are fixed circumferentially to the rotor lamination stack.

Mechanical field-attenuation mechanisms are fundamentally known from the prior art. Particular mechanical field-attenuation mechanisms in the context of the present disclosure are described in patent publications DE102022106944A1,DE102022106945A1 (having corresponding U.S. pat. publ. US20250202327A1), DE102021101904B3, DE102021101898A1 and DE102021101900A1 and are hereby incorporated by reference in the disclosure of the present application.

It may further be that the first rotor body and the second rotor body are rotatable relative to each other against the effect of a first torsional stiffness mechanism about a common rotational axis by means of a mechanical field-attenuation mechanism, the first torsional stiffness mechanism being designed as a first torsion spring arrangement having a first torsion spring, which can be arranged coaxially with respect to the rotational axis and between the first rotor body and the second rotor body or between one of the rotor bodies and a rotor shaft in such a way that the rotation of one of the rotor bodies, which begins during the adjustment of the field-attenuation mechanism, brings about an opening or closing actuation of the first torsion spring.

The design of a torsional stiffness mechanism as a torsion spring arrangement for defining an adjustment characteristic curve for weakening the magnetic field by relative rotation of the rotor bodies allows in particular the reduction of the centrifugal force influence on the adjustment characteristic curve and its hysteresis.

According to an advantageous embodiment of the present disclosure, it is possible for the first torsion spring arrangement to have a second torsion spring which is arranged coaxially with respect to the rotational axis of the rotor and between the first rotor body and the second rotor body or between one of the rotor bodies and the rotor shaft in such a way that the rotation of one of the rotor bodies, which begins during adjustment of the field-attenuation mechanism, causes an opening or closing actuation of the second torsion spring. The advantage of this design is that a second torsion spring makes it possible to model and precisely adjust the adjustment characteristic curve. The torsion springs can be substantially identical or different, depending on which application-specific requirements need to be implemented by the desired adjustment characteristic curve. The torsion springs can be connected in series or parallel to each other.

According to a further development of the present disclosure, it is also possible for the first torsion spring to have a first spring leg extending radially into the first rotor body and/or a second spring leg extending radially into the second rotor body, and/or it is also possible for the first torsion spring to have a first spring leg extending axially into the first rotor body and/or a second spring leg extending axially into the second rotor body, and/or
it is also possible for the second torsion spring to have a first spring leg extending radially into the first rotor body and/or a second spring leg extending radially into the second rotor body,
and/or it is also possible for the second torsion spring to have a first spring leg extending axially into the first rotor body and/or a second spring leg extending axially into the second rotor body. This makes it possible to achieve particularly compact torsional stiffness mechanisms radially or axially according to the given installation space situation.

According to an advantageous embodiment of the present disclosure, it is possible for the lever element to be rotatably mounted on a lever shaft relative to an annular lever carrier, which is positioned coaxially with respect to the rotor shaft, and/or it is possible for the lever element to be mounted on a lever shaft, which in turn is mounted in at least one of the rotor bodies.

According to a further development of the present disclosure, it is also possible for the lever element to be non-rotatably connected to the lever shaft and for the lever shaft to be rotatably mounted in a bearing bush of the lever carrier and/or of at least one rotor body.

Furthermore, according to a likewise advantageous embodiment of the present disclosure, it is possible for the lever shaft to be rotatably mounted by means of a rolling bearing in the bearing bush. The advantageous effect of this design is that the bearing can be designed with particularly low friction, which also has a positive influence on the adjustment characteristic curve of the field-attenuation mechanism. In this context, the design of the rolling bearing as a needle roller bearing is particularly possible.

According to a further particularly embodiment of the present disclosure, it is possible for the lever element to have a first lever disk with the first lever section and a second lever disk with the second lever section axially spaced from the first lever disk.

Furthermore, the present disclosure can also be further developed in such a way that the rotor has a plurality of lever elements which are each arranged pivotably in a circumferentially distributed manner on the rotor shaft, wherein the lever elements each have a first lever disk and a second lever disk and two first lever disks are arranged in each case on a first lever shaft and two second lever disks are arranged in each case on a second lever shaft.

In an equally envisioned embodiment of the present disclosure, it is also possible for the first lever disk and the second lever disk to be shaped substantially identically. This enables a particularly cost-efficient design of the rotor due to an increased proportion of common parts.

It is also advantageous to further develop the present disclosure in such a way that the first lever disk and/or the second lever disk are/is punched from a sheet metal, which can contribute to a particularly cost-effective production of the lever disks.

According to a further embodiment of the subject matter of the present disclosure, it is possible for the rotor bodies to be constructed in two parts, having an inner ring disk and an outer ring disk torque-transmittingly coupled to the inner ring disk, wherein the permanent magnets are only arranged in the outer ring disk and the mechanical field-attenuation mechanism is only arranged in and/or on the inner ring disk. The advantage of this is in particular that the mechanical field-attenuation mechanism can thus be manufactured independently of the magnetic region of a rotor body, which can improve flexibility in the design and manufacture of the electrical machine. The inner ring disk is particularly made of steel, in particular hardened steel.

The object of the present disclosure is further addressed by an electric machine including a stator and a rotor separated from the stator by an air gap, the rotor being designed according to one of claims 1-9.

### BRIEF DESCRIPTION OF THE DRAWINGS

The present disclosure is explained in more detail below with reference to figures without limiting the general concept of the present disclosure.

In the drawings:

FIG. 1 shows a cross-sectional view of an electric machine;

FIG. 2 shows a schematic block circuit view of a rotor with a mechanical field-attenuation mechanism;

FIG. 3 shows a rotor in a cross-sectional view;

FIG. 4 shows a detailed view of a rotor in a cross-sectional view;

FIG. 5 shows an exploded perspective representation of a first embodiment of a torsion spring arrangement with two rotor bodies;

FIG. 6 shows a perspective view of a first embodiment of a torsion spring arrangement with two rotor bodies in an assembled state;

FIG. 7 shows a first embodiment of a rotor in a perspective representation;

FIG. 8 shows a first embodiment of the rotor in a schematic axial sectional representation;

FIG. 9 shows a detailed view of the bearing of the lever elements in the first embodiment of the rotor in an axial sectional view;

FIG. 10 shows a first embodiment of the rotor in a first, field-strengthened operating state in a combined cross-sectional view of the first and second rotor bodies;

FIG. 11 shows a first embodiment of the rotor in a second, field-weakened operating state in a combined cross-sectional view of the first and second rotor bodies;

FIG. 12 shows a first embodiment of the rotor in a third field-strengthened operating state in a combined cross-sectional view of the first and second rotor bodies;

FIG. 13 shows a lever carrier in a perspective view;

FIG. 14 shows a second embodiment of a rotor in a first perspective representation;

FIG. 15 shows a second embodiment of a rotor in a second perspective representation;

FIG. 16 shows a second embodiment of a rotor in a first schematic axial sectional representation;

FIG. 17 shows a second embodiment of a rotor in a second schematic axial sectional representation;

FIG. 18 shows a third embodiment of a rotor in a perspective representation; and

FIG. 19 shows two lever disks, each in a perspective view.

### DETAILED DESCRIPTION

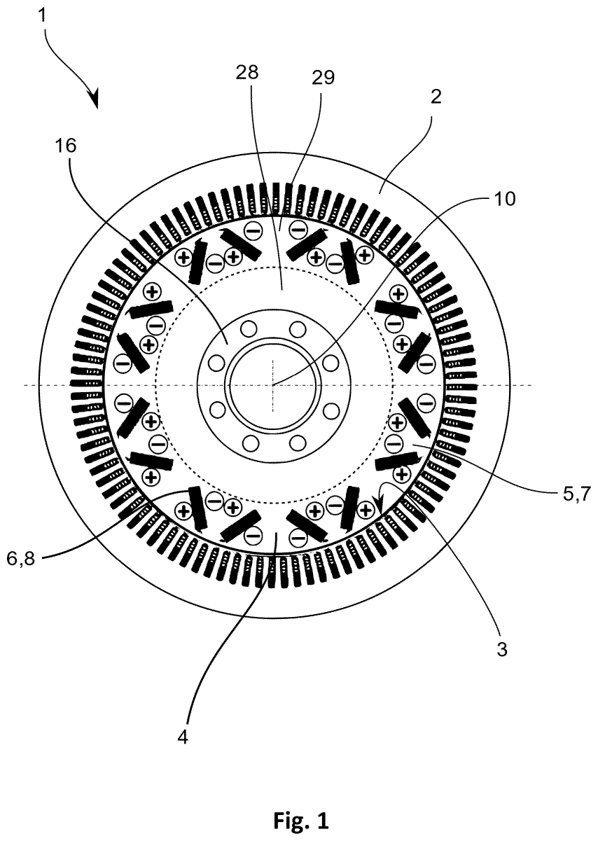

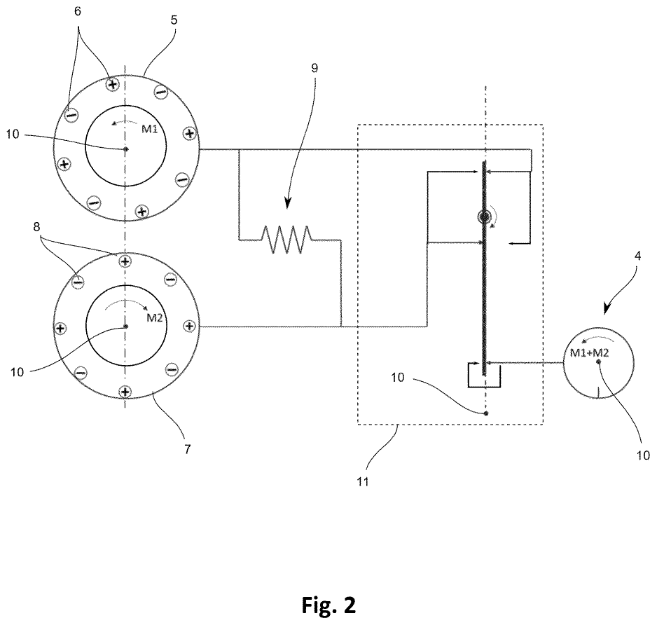

FIG. 1 discloses an electric machine 1, in particular for use within a drivetrain of a hybrid or fully electrically driven motor vehicle. The electric machine 1 configured as a radial flux machine includes a stator 2 and a rotor 4 separated from the stator 2 by an air gap 3, the rotor 4 having at least a first rotor body 5 with a first group of permanent magnets 6 and a second rotor body 7 with a second group of permanent magnets 8, which can be easily understood by looking at FIG. 1 together with FIG. 2.

The first rotor body 5 and the second rotor body 7 can be rotated relative to each other about a common rotational axis 10 by means of a mechanical field-attenuation mechanism 11 against the effect of a first torsional stiffness mechanism 9.

The two rotor bodies 5, 7 are formed substantially from identical rotor laminations, and the position and the number of the permanent magnets 6 of the first group and the number of permanent magnets 8 of the second group in the rotor bodies 5, 7 are identical.

The field-attenuation mechanism 11, shown by way of example in FIG. 2, includes an unspecified lever element which is pivotable about a fulcrum, wherein the first rotor body 5 can be coupled to a first lever section and the second rotor body 7 can be coupled to a second lever section of the lever element. The first lever section and the second lever section are arranged on opposite sides of the lever, such that the first rotor body 5 and the second rotor body 7 can be rotated relative to each other by tilting of the lever element for a desired adjustment of the mechanical field-attenuation mechanism 11. This field-attenuation mechanism 11 is described in detail in DE102022106944A1and DE102022106945A1, so reference is made here to these documents in order to avoid repetition.

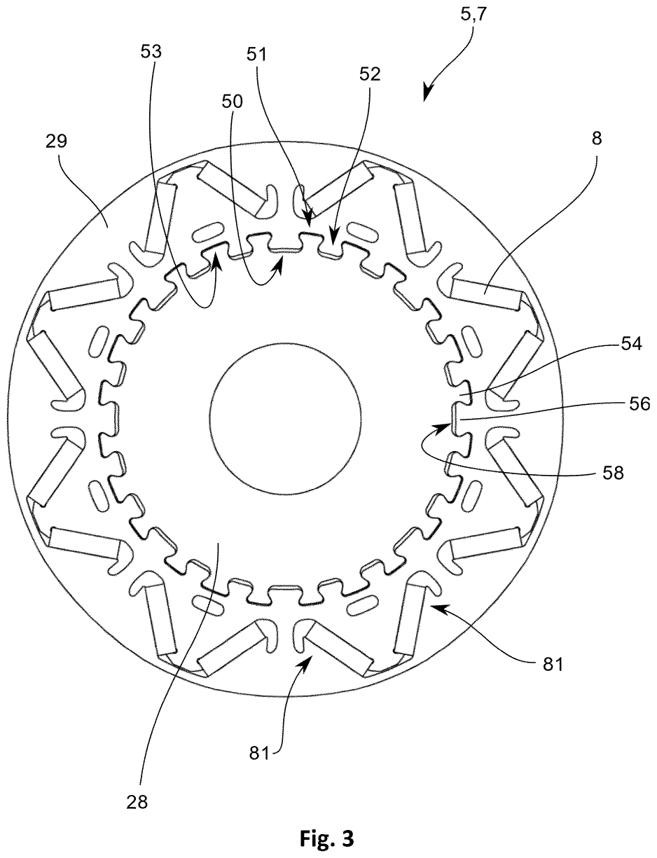

The first torsional stiffness mechanism 9 is designed as a first torsion spring arrangement 12 having a first torsion spring 13, which is arranged coaxially with respect to the rotational axis 10 and between the first rotor body 5 and the second rotor body 7 in such a way that the rotation of one of the rotor bodies 5, 7, which begins during adjustment of the field-attenuation mechanism 11, brings about an opening or closing actuation of the first torsion spring 13. Although it is not shown in FIGS. 2-3, it is nevertheless possible for the first torsion spring 13 to also be torque-transmittingly arranged between one of the rotor bodies 5, 7 and the rotor shaft 16.

As already indicated in FIG. 1, the rotor bodies 5, 7 are each constructed in two parts, including an inner ring disk 28 torque-transmittingly connected to a rotor shaft 16 and an outer ring disk 29 torque-transmittingly coupled to the inner ring disk 28, the permanent magnets 6, 8 being arranged only in the outer ring disk 29 formed from an electrical steel sheet. The inner ring disk 28 is made of a steel, in particular a hardened steel.

FIG. 3 shows an embodiment in which the inner ring disk 28 and the outer ring disk 29 are form-fittingly connected to each other in a torque-transmitting manner. For this purpose, the inner ring disk 28 has external toothing 51 on its outer lateral surface 50, which engages in a corresponding internal toothing 52 on an inner lateral surface 53 of the outer ring disk 29. In this embodiment, the external toothing 51 and the internal toothing 52 are designed as splines. In order to facilitate the joining of these splines, the external toothing 51 and/or the internal toothing 52 can have a chamfer.

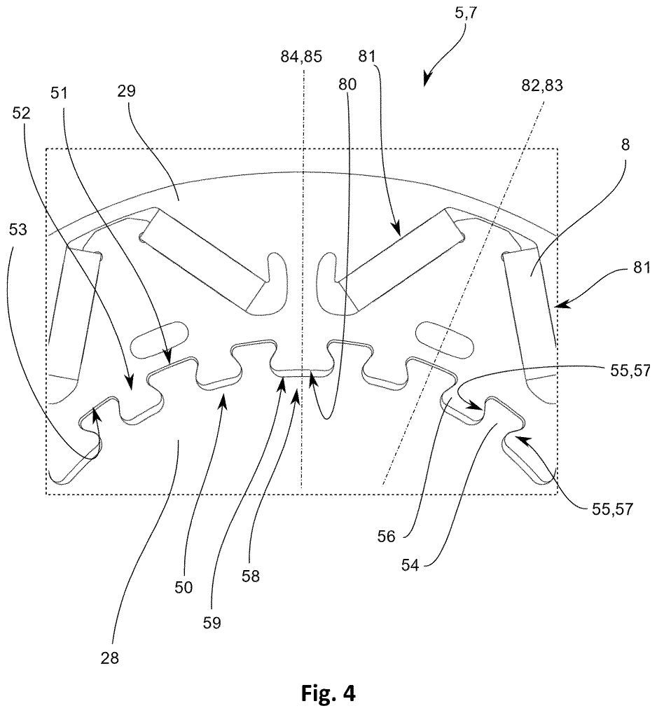

It can be seen from the detailed representation in FIG. 4 that the teeth 54 of the external toothing 51 each has a first undercut 55, and the teeth 56 of the internal toothing 52 also have a second undercut 57, the first undercut 55 and the second undercut 57 being designed in such a way that a force can be transmitted radially between the meshing internal toothing 52 and the external toothing 51. To achieve this, the teeth 54 of the external toothing 51 and the teeth 56 of the internal toothing 52 are dovetail-shaped in cross-section. In this case, the two ring disks 28, 29 only touch on the inclined flanks of the dovetail-shaped teeth 54, 56. The high precision of the tooth shape for a form-fit connection is therefore limited to the inclined flanks.

This also allows larger radii to be used in the tooth base of the ring disks 28, 29. This reduces the local stresses and enables faster, more cost-effective production of the toothings 51, 52, e.g., by selecting a milling cutter with a larger diameter. The undercut 55, 57 is thus created by the inclined lateral flanks of the teeth 54, 56. In this form, the openings of the tooth gaps in the ring disks 28, 29 are wider, which makes it easier and more cost-effective to manufacture the toothing, e.g., by broaching, shaping, or milling.

The external toothing 51 also has a groove 58 with a groove base 59 between two circumferentially adjacent teeth 54, into which groove a tooth 56 of the internal toothing 52 engages with a tooth head 80, and the tooth head 80 is subject to play in relation to the groove base 59, which can be easily understood from the gap shown in FIG. 4. With this design, an overlap can be specifically provided in the tooth flanks of the meshing teeth 54, 56, which leads to an inward prestress of the inner ring disk 28 with the outer ring disk 29 during assembly and thus further reduces the stresses in the ring disks 28, 29 under rotational speed.

The permanent magnets 6, 8 are arranged in cross-section in pairs in a V-shape distributed over the circumference of an outer ring disk 29, the free legs 81 of the V-shaped arrangement extending radially inwards, and the V-shaped arrangement having a radially extending mirror axis 82, which extends coaxially with respect to a radially extending mirror axis 83 of a tooth 54, 56 of the internal toothing 52 or external toothing 51. At the same time, a radially extending mirror axis 84 is defined between two circumferentially adjacent V-shaped arrangements and extends coaxially with respect to a radially extending mirror axis 85 of a tooth 56 of the internal toothing 52 or external toothing 51. In this context, FIG. 4 also clearly shows that the meshing teeth 54, 56 through which the mirror axes 82, 83 extend are wider circumferentially than the circumferentially adjacent teeth 54, 56. The same applies to the meshing teeth 54, 56 through which the mirror axes 84, 85 extend.

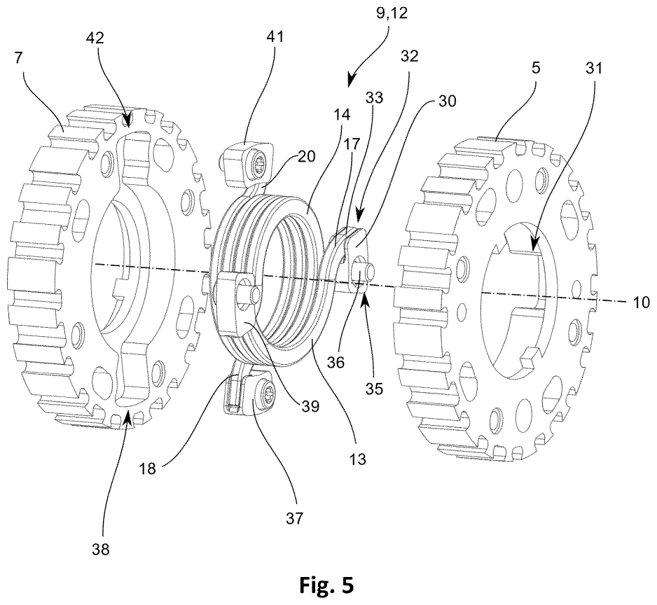

The first rotor body 5 and the second rotor body 7 can be rotated relative to each other about a common rotational axis 10 by means of a mechanical field-attenuation mechanism 11 against the effect of a first torsional stiffness mechanism 9. This is explained in more detail below with reference to FIG. 5. As can be seen from FIG. 5, the first torsional stiffness mechanism 9 is designed as a first torsion spring arrangement 12 having a first torsion spring 13, which is arranged coaxially with respect to the rotational axis 10 and between the first rotor body 5 and the second rotor body 7 in such a way that the rotation of one of the rotor bodies 5, 7, which begins during adjustment of the field-attenuation mechanism 11, brings about an opening or closing actuation of the first torsion spring 13. Although it is not shown in the Figures, it is nevertheless possible for the first torsion spring 13 to also be torque-transmittingly arranged between one of the rotor bodies 5, 7 and the rotor shaft 16.

The first torsion spring arrangement 12 has a second torsion spring 14, which is arranged coaxially with respect to the rotational axis 10 of the rotor 4 and between the first rotor body 5 and the second rotor body 7 in such a way that the rotation of one of the rotor bodies 5, 7, which begins during adjustment of the field-attenuation mechanism 11, brings about an opening or closing actuation of the second torsion spring 14. As shown in FIG. 3, the first torsion spring 13 and the second torsion spring 14 are designed substantially the same and are arranged rotated relative to each other about the rotational axis 10 through approximately 180°, such that the first spring leg 17 and the second spring leg 18 of the first torsion spring 13 point radially outwards offset by 90° circumferentially and the first spring leg 19 and the second spring leg 20 of the second torsion spring 14 are also oriented radially outwards offset by 90° circumferentially.

The first torsion spring 13 has a first spring leg 17 extending radially into the first rotor body 5 and a second spring leg 18 extending radially into the second rotor body 7. Similarly, the second torsion spring 14 also has a first spring leg 19 extending radially into the first rotor body 5 and a second spring leg 20 extending radially into the second rotor body 7.

The first spring leg 17 of the first torsion spring 13 is held in a first receiving shoe 30, which in turn is received in a first receiving pocket 31 of the first rotor body 5 and fixed to the first rotor body 5 in such a way that the first spring leg 17 of the first torsion spring 13 is coupled to the first rotor body 5 axially as well as circumferentially without play in relation to the latter. The first receiving shoe 30 can be inserted into the first receiving pocket 31 with play.

It can also be seen from FIG. 5 that the first receiving shoe 30 has a first receiving groove 32, in which the first spring leg 17 of the first torsion spring 13 is arranged without play, for example by means of a press fit.

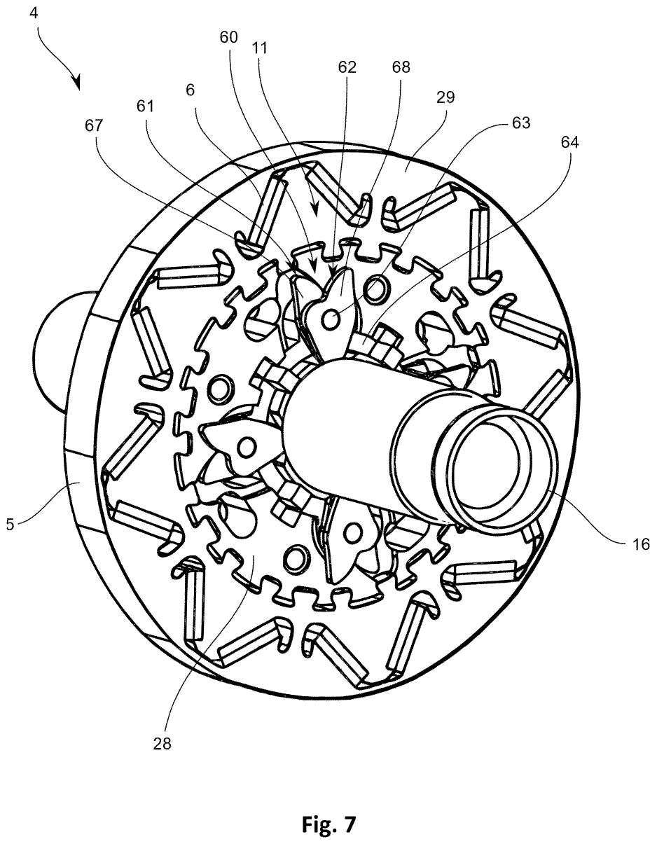

The first spring leg 17 of the first torsion spring 13 protrudes from the first receiving groove 32, and the section 33 protruding from the first receiving groove 32 bears against a wall 34 of the first receiving pocket 31. In this way, part of the shoe load can be absorbed by the rotor body 5. The wall 34 of the first receiving pocket 31 has a convex contour which projects into the first receiving pocket 31 and which can also be clearly seen from the detailed representation in FIG. 7. This ensures, for example, that the position of the spring leg 17 can also be adjusted in the direction of rotation.

FIG. 5 also shows that the first receiving shoe 30 has a first opening 35 through which a first fastening means 36 passes, by means of which the first receiving shoe 30 is fixed to the first rotor body 5.

FIG. 5 also shows that the second spring leg 18 of the first torsion spring 13 is held in a second receiving shoe 37, which in turn is received in a second receiving pocket 38 of the second rotor body 7 and fixed to the first rotor body 7 in such a way that the second spring leg 18 of the first torsion spring 13 is coupled to the second rotor body 7 axially as well as circumferentially without play in relation to the latter.

The first spring leg 19 of the second torsion spring 14 is also held in a similar manner in a third receiving shoe 39, which in turn is received in a third receiving pocket of the first rotor body 5 and fixed to the first rotor body 5 in such a way that the first spring leg 19 of the second torsion spring 14 is coupled to the first rotor body 5 axially as well as circumferentially without play in relation to the latter.

Finally, the second spring leg 20 of the second torsion spring 14 is also held in a fourth receiving shoe 41, which in turn is received in a fourth receiving pocket 42 of the second rotor body 7 and fixed to the second rotor body 7 in such a way that the second spring leg 20 of the second torsion spring 14 is coupled to the second rotor body 7 axially and circumferentially without play in relation to the latter.

FIG. 5 also shows that the first receiving shoe 30, the second receiving shoe 37, the third receiving shoe 39 and the fourth receiving shoe 41 are formed the same.

By means of the receiving shoes 30, 37, 39, 41, elements which are adjustable and fixable in terms of their position within a receiving pocket 31, 38, 42 are thus arranged between the spring legs 17, 18, 19, 20 and the rotor bodies 5, 7. The receiving shoes 30, 37, 39, 41 are pressed onto the spring legs 17, 18, 19, 20, for example by a corresponding oversize, so that they are fixed to each other without play. The spring legs 17, 18, 19, 20 with the pre-assembled receiving shoes 30, 37, 39, 41 can be positioned in the rotor bodies 5, 7 using an assembly tool (not shown). Since a gap is formed between the receiving pockets 31, 38, 42 and the receiving shoes 30, 37, 39, 41, i.e., the receiving shoes 30, 37, 39, 41 engage in the receiving pockets 31, 38, 42 with play, the position of the receiving shoes 30, 37, 39, 41 in the receiving pockets 31, 38, 42 can be adjusted. The receiving shoes 30, 37, 39, 41 then positioned in the receiving pockets 31, 38, 42 can then be fixed by the fastening means 36. These are shown as screws in the Figures. However, they can also be designed as rivets or the fastening means 36 is a soldered or welded joint.

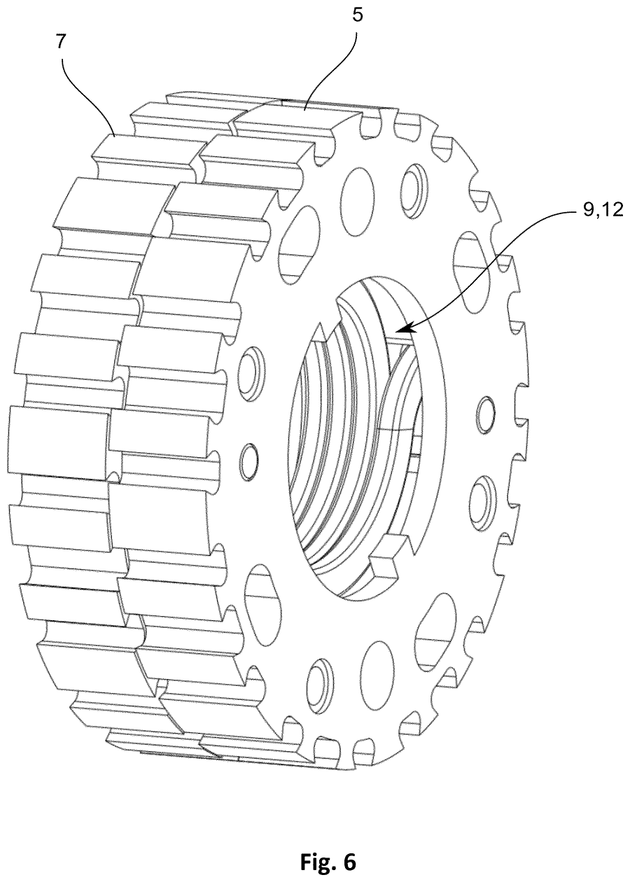

FIG. 6 shows the arrangement known from FIG. 5 in an assembled state.

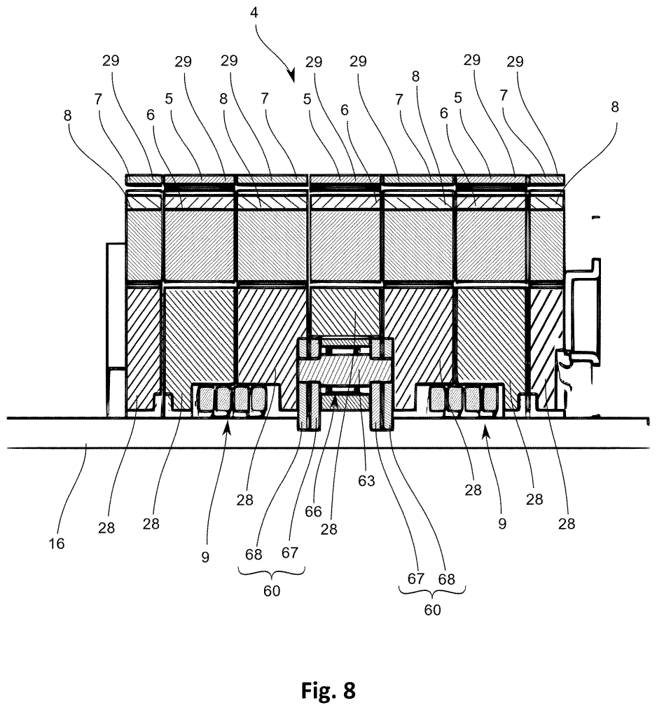

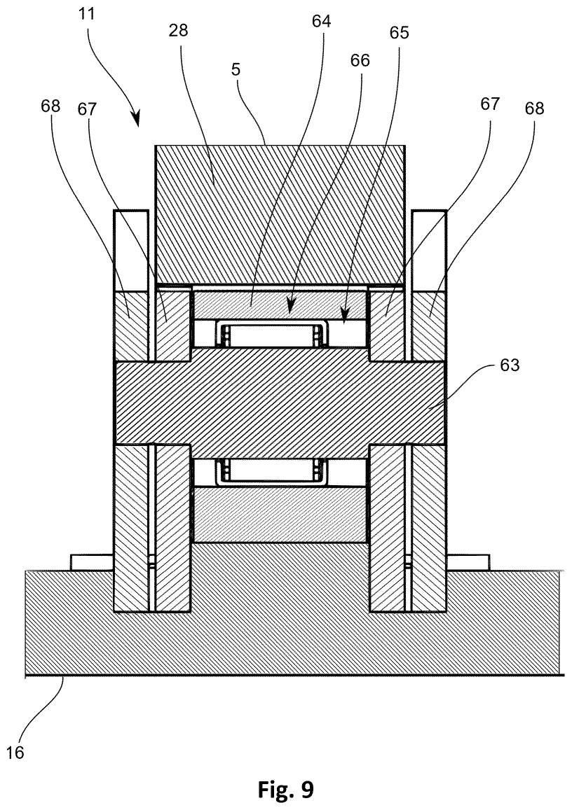

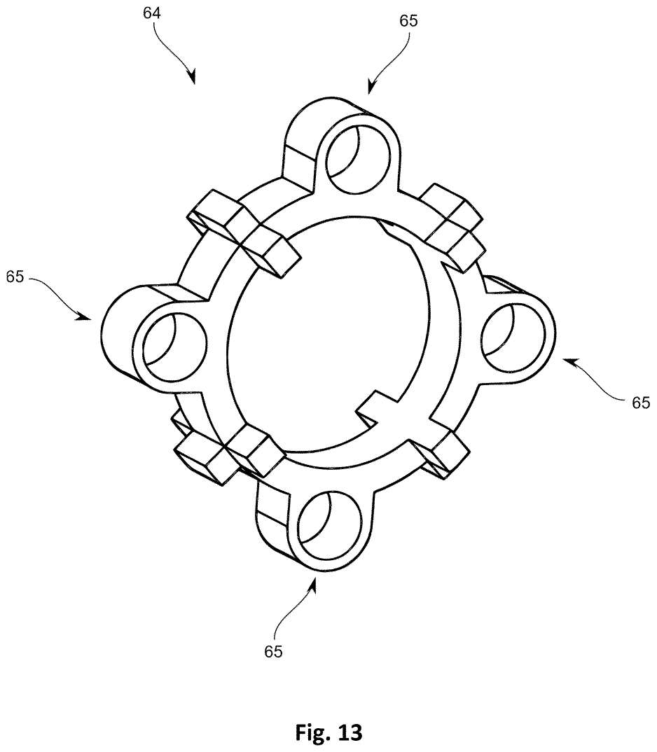

The mechanical field-attenuation mechanism 11 is explained in more detail below with reference to FIGS. 7-17.

FIG. 7 shows a rotor 4 for an electric machine 1 having a first rotor body 5 with a first group of permanent magnets 6. The axially adjacent second rotor body 7 is not shown in order to allow a better view of the field-attenuation mechanism 11.

The first rotor body 5 and the second rotor body 7 can be rotated relative to each other about a common rotational axis 10 by means of the mechanical field-attenuation mechanism 11 against the effect of a first torsional stiffness mechanism 9. The field-attenuation mechanism 11 includes a first lever element 60 which can be pivoted about a fulcrum, wherein the first rotor body 5 can be coupled to a first lever section 61 and the second rotor body 7 can be coupled to a second lever section 62 of the lever element 60 and the first lever section 61 and the second lever section 62 are arranged on circumferentially opposite sides of the lever element 60, such that the first rotor body 5 and the second rotor body 7 can be rotated relative to each other by tilting of the lever element 60 for a desired adjustment of the mechanical field-attenuation mechanism 11.

Coaxially within the first rotor body 5 and the second rotor body 7, a rotor shaft 16 is torque-transmittingly to the first rotor body 5 and the second rotor body 7 by means of the lever element 60. The lever element 60 is also pivotably mounted on the rotor shaft 16.

The lever element 60 is rotatably mounted on a lever shaft 63 relative to an annular lever carrier 64, which is positioned coaxially with respect to the rotor shaft 16. In the embodiment shown, the lever element 60 is connected to the lever shaft 63 in a rotationally fixed manner and the lever shaft 63 is in turn rotatably mounted in a bearing bush 65 of the lever carrier 64 by means of a rolling bearing 66.

FIG. 7 further shows that the lever element 60 has a first lever disk 67 with the first lever section 61 and a second lever disk 68 with the second lever section 62 axially spaced from the first lever disk 67.

The first lever disk 67 and the second lever disk 68 are substantially identically shaped but are arranged rotated by 180° around their radial axis.

In the embodiment of the present disclosure shown, the rotor 4 has a plurality of lever elements 60, which are each arranged pivotably in a circumferentially distributed manner on the rotor shaft 16, wherein the lever elements 60 each have a first lever disk 67 and a second lever disk 68.

There is therefore a contact point from the lever element 60 (inside) to the rotor shaft 16 and a contact point from the lever element 60 radially outside to one of the two rotor bodies 5, 7. These radially outer contact points are contact points of a contact that continues to roll and move radially outwards during the adjustment with increasing tilting of the lever element 60. The inner contact point, on the other hand, does not change its radial position, since it remains at the same radial distance from the rotational axis of the rotor shaft 16 as the center of rotation of the lever shafts 63, which form the tilting axis of the lever elements 60.

The lever elements 60 are designed as punchable sheet metal parts which provide the lever sections 61, 62, 71, 72 for the contact points to the rotor shaft 16 or to the rotor bodies 5, 7 in the form of the sheet thickness at their cut surface and have an opening 69 for the insertion of a lever shaft 63. Since the contact regions are quite narrow as a result and therefore have higher pressures during operation, the lever element 60 and the regions of the rotor bodies 5, 7 in contact with the lever element 60 may be made of a hardenable or tempered material and no longer of electrical steel.

The radially acting centrifugal forces of the lever elements 60 are supported in the rotor bodies 5, 7 via the lever shaft 63 and the rolling bearing 66. The lever elements 60 are only subjected to low stresses. Although not shown in the Figures, the lever shaft 63 can be mounted by means of a plain bearing.

The lever elements 60 are therefore mounted on the lever shafts 63, wherein the lever shafts 63 are in contact, in a torque-transmitting manner circumferentially via the lever elements 60, exclusively with the first rotor body 5 in a first operating state and exclusively with the second rotor body 7 in a second operating state.

Three embodiments are described below, in which the transfer of the contact points at transitions between the operating states of the rotor is realized differently from one another.

In the embodiment shown in FIGS. 7-12, a first lever disk 67 and a second lever disk 68 are each arranged on a first lever shaft 63. In this case, the lever disks 67, 68 of a lever element 60 are each seated on a common lever shaft 63, which is mounted in a ring-like lever carrier 64, for adjustment into the two operating states.

For one operating state, the lever carrier 64 is supported in a torque-transmitting manner circumferentially via a toothing or via axially engaging fingers on an inner ring disk 28 of one of the rotor bodies 5, 7; for the other operating state, it is supported on an inner ring disk 28 of the other rotor body 5, 7. The ring disks 28, each driven by the lever elements 60, can move, as a result of cut-outs provided for this purpose, relative to the fingers or toothings of the lever carrier 64 over a sufficiently large angle of rotation without collisions. During transitions between motor and generator operation, the contact points are transferred to the toothing or fingers at a different point on the lever carrier 64. The radially acting centrifugal forces of the lever elements 60 are supported in the lever carrier 64 via the lever shafts 63.

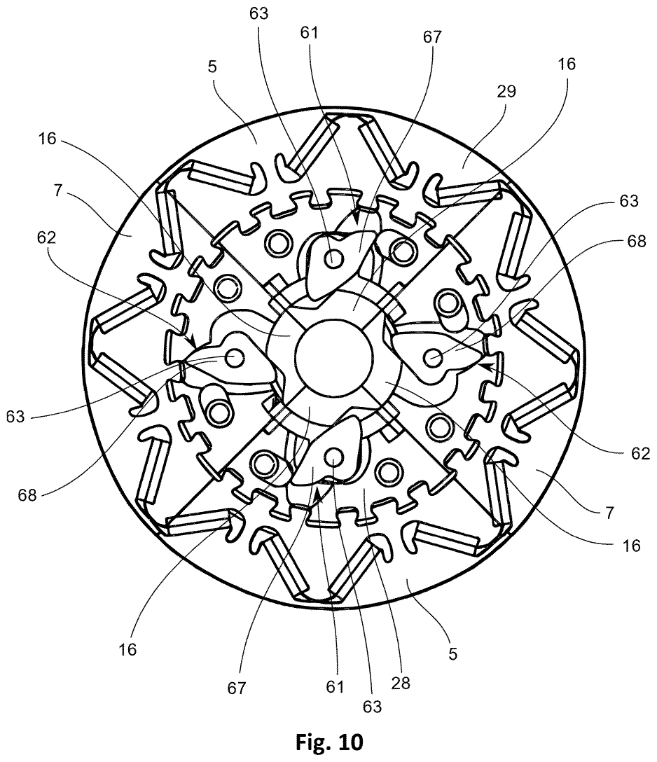

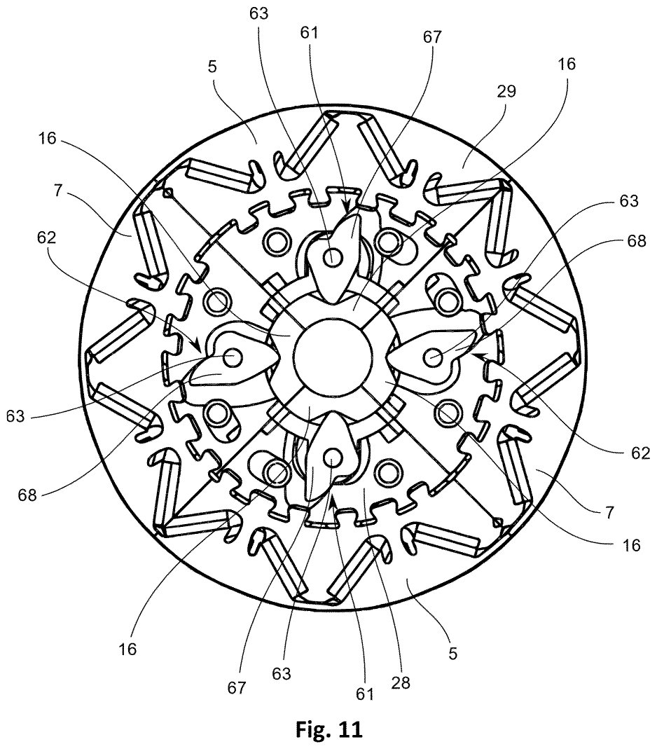

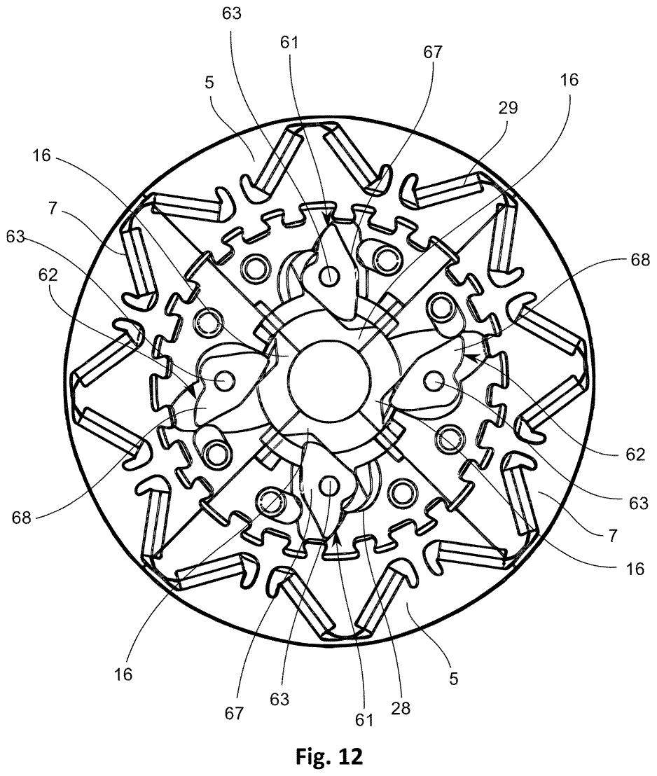

FIGS. 10-12 show this embodiment in three different operating states. FIG. 10 shows the position of the lever disks 67, 68 in a first, field-strengthened, shear-stressed operating state in a combined cross-sectional view of the first and second rotor bodies 5, 7. FIG. 11 shows the same configuration in a field-weakened operating state. FIG. 12 shows a field-strengthened, tension-stressed operating state.

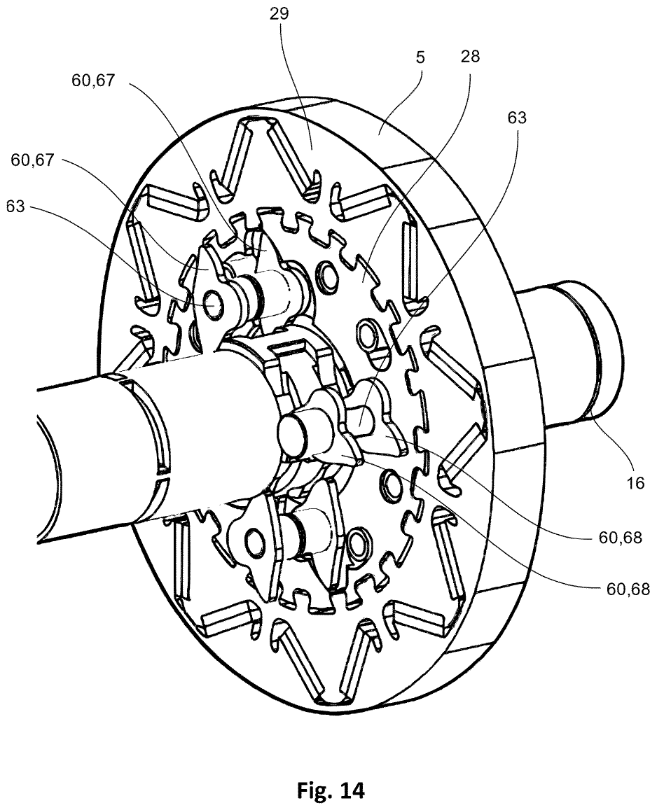

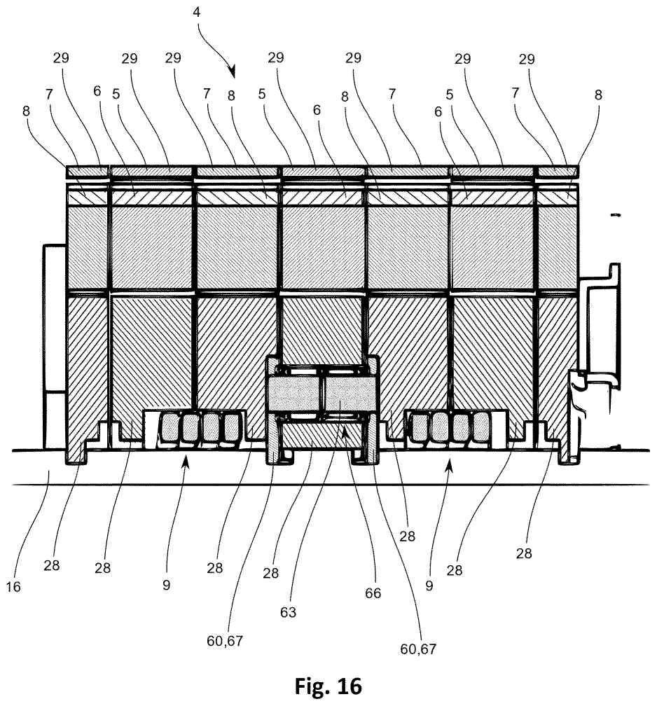

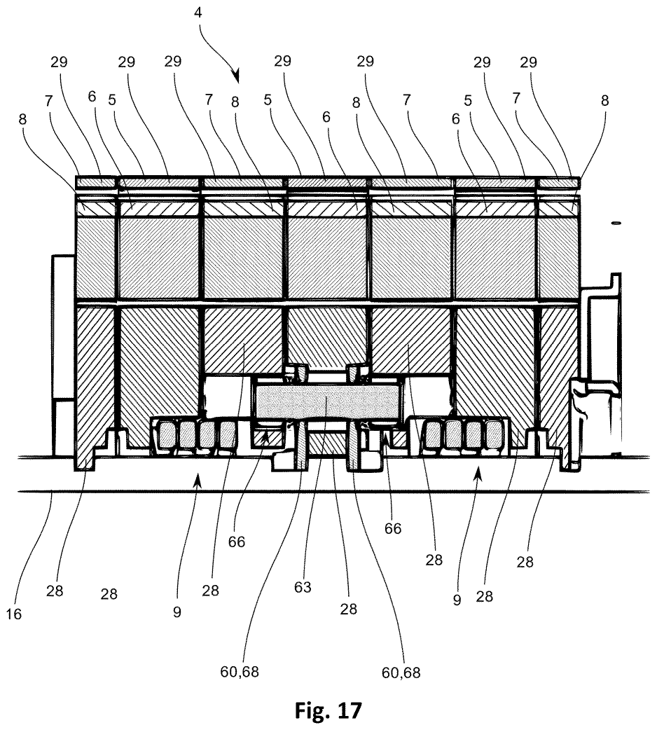

FIGS. 14-17 show an embodiment in which two first lever disks 67 are arranged on a first lever shaft 63 and two second lever disks 68 are arranged on a second lever shaft 63. In these figures, two longitudinal sections of the rotor 4 rotated by 90° around the rotational axis of the rotor shaft 16 show an embodiment in which the lever elements 60 are located on separate lever shafts 63 for adjustment for both operating states. In FIG. 16, for an operating state with two centrally located rolling bearings 66, one part of the lever shafts 63 is mounted in bearing seats of the inner ring disks 28 of the first rotor body 5 and is thus supported in a torque-transmitting manner circumferentially via contact points on the corresponding lever shafts 63. In FIG. 17, for the other operating state with two axially spaced rolling bearings 66, the other part of the lever shafts 63 is mounted in bearing seats of the two adjacent inner ring disks 28 of the second rotor body 7 and thus supported in a torque-transmitting manner circumferentially via other contact points.

The inner ring disks 28, each driven by the lever elements 60, can move, as a result of cut-outs provided for this purpose, relative to the lever shafts 63 supported in the other ring disks 28 together with the lever elements 60 over a sufficiently large angle of rotation without collisions. During transitions between motor and generator mode, the contact points are each transferred to the bearing of the other lever shafts 63.

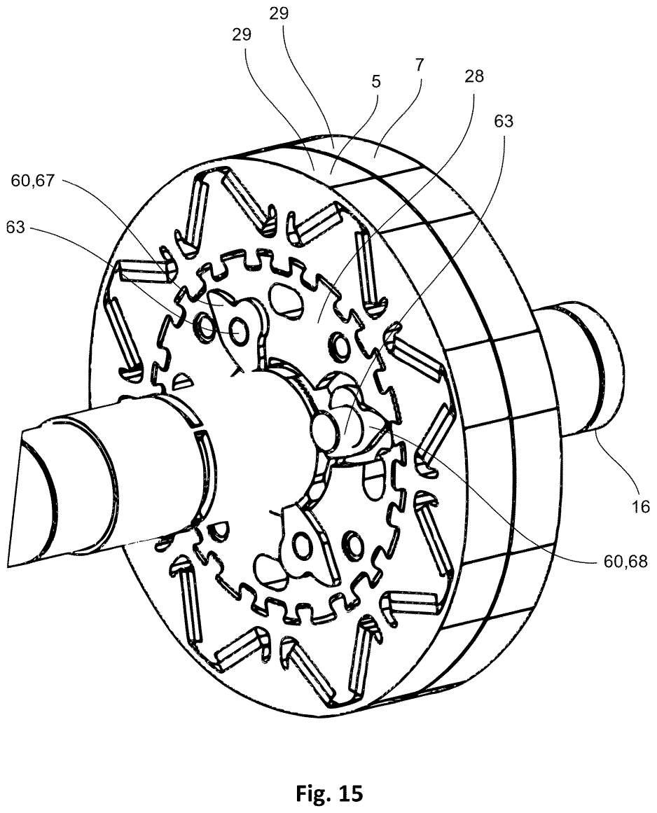

FIG. 14 shows a perspective view of the mechanical field-attenuation mechanism 11 inside the rotor 4, as known from FIGS. 16-17. A deflected position of an operating state is shown here, in which the lever disks 67 of the lever elements 60 rotate the first rotor body 5 clockwise when the rotor shaft 16 is rotated counterclockwise. The lever disks 68 of the lever elements 60 are free. FIG. 15 shows a deflected position in the other operating state, in which the lever disks 68 of the lever elements 60—mounted in the axially adjacent inner ring disks 28—rotate the second rotor body 7 counterclockwise when the rotor shaft 16 is rotated clockwise. The lever disks 67 of the lever element 60 are free.

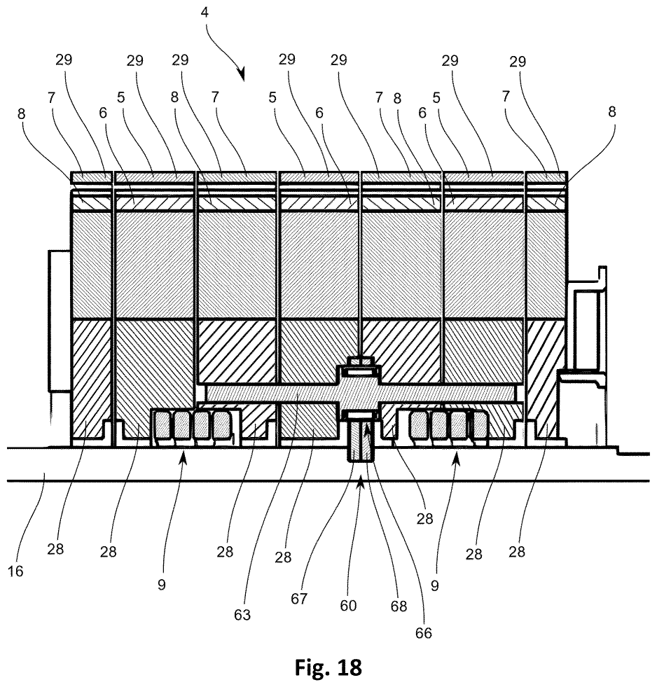

FIG. 18 shows a longitudinal section of the rotor 4 in an embodiment where the lever elements 60 for adjusting the rotor bodies 5, 7 to the two operating states (field attenuation/field strengthening) are mounted on a common lever shaft 63. For one operating state, these lever shafts 63 are supported in this case on the left over a short axial distance and on the right over a longer axial distance in the inner ring disk 28 of the first rotor body 5 at the corresponding contact points circumferentially in a torque-transmitting manner; for the other operating state, they are supported on the left over a longer axial distance and on the right over a short axial distance in the inner ring disks 28 of the second rotor body 7. In the opposite circumferential direction, the lever shafts 63 can move freely relative to the non-supporting rotor body 5, 7, as a result of cut-outs provided for this purpose, over a sufficiently large angle of rotation in relation to the rotational axis of the rotor shaft 16. During transitions between motor and generator operation, the contact points on the other side of the circumference of the lever shafts 63 are transferred to the other axial distances.

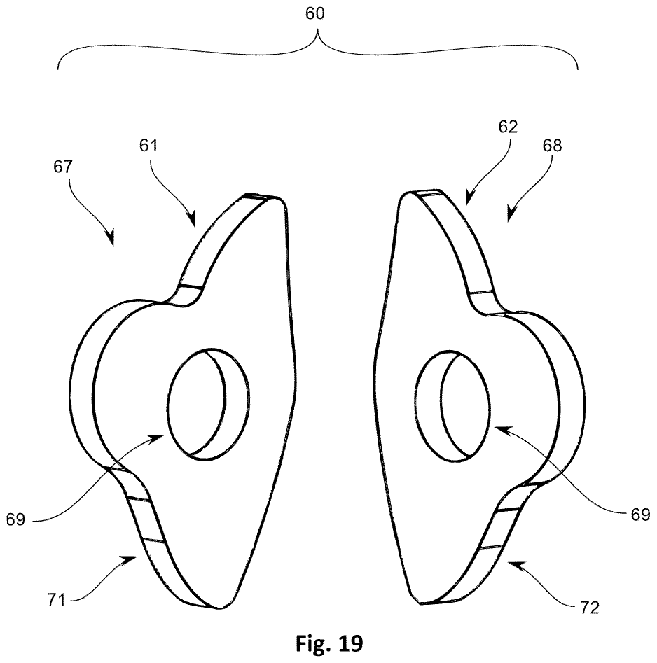

FIG. 19 shows the lever disks 67, 68, which can be produced as simple punched parts, with their respective lever sections 61, 62 to the rotor shaft 16 and the lever sections 71, 72 to the rotor bodies 5, 7 as well as the openings 69 for receiving the lever shaft 63. The first lever disk 67 and the second lever disk 68 are punched from a sheet metal.

The present disclosure is not limited to the embodiments shown in the figures. The above description is therefore not to be regarded as limiting, but rather as illustrative. The following claims are to be understood as meaning that a stated feature is present in at least one embodiment of the present disclosure. This does not exclude the presence of further features. Where the claims and the above description define ‘first’ and ‘second’ features, this designation serves to distinguish between two features of the same type without defining an order of precedence.

### LIST OF REFERENCE SIGNS

1 Electric machine
2 Stator
3 Air gap
4 Rotor
5 Rotor body
6 Permanent magnets
7 Rotor body
8 Permanent magnets
9 Torsional stiffness mechanism
10 Rotational axis
11 Field-attenuation mechanism
12 Torsion spring arrangement
13 Torsion spring
14 Torsion spring
16 Rotor shaft
17 Spring leg
18 Spring leg
19 Spring leg
20 Spring leg
28 Ring disc
29 Ring disc
28 Ring disc
29 Ring disc
30 Receiving shoe
31 Receiving pocket
32 Receiving groove
33 Section
34 Wall
35 Opening
36 Fastening means
37 Receiving shoe
38 Receiving pocket
39 Receiving shoe
41 Receiving shoe
42 Receiving pocket
50 Lateral surface
51 External toothing
52 Internal toothing
53 Lateral surface
54 Teeth
55 Undercut
56 Teeth
57 Undercut
58 Groove
59 Groove base
60 Lever element
61 Lever section
62 Lever section
63 Lever shaft
64 Lever carrier
65 Bearing bush
66 Rolling bearing
67 Lever disk
68 Lever disk
69 Opening
71 Lever section
72 Lever section
80 Tooth head
81 Leg
82 Mirror axis
83 Mirror axis
84 Mirror axis
85 Mirror axis

1. A rotor for an electric machine, wherein the rotor has at least one first rotor body with a first group of permanent magnets and a second rotor body with a second group of permanent magnets, wherein the first rotor body and the second rotor body can be rotated relative to each other about a common rotational axis against the effect of a first torsional stiffness mechanism by a mechanical field-attenuation mechanism, the the field-attenuation mechanism comprises a lever element which is pivoted about a fulcrum, wherein the first rotor body is coupled to a first lever section and the second rotor body is coupled to a second lever section of the lever element, and the first lever section and the second lever section are arranged on opposite sides of the lever element relative to a circumferential direction so that by tilting the lever element, the first rotor body and the second rotor body are deliberately rotated relative to each other in order to produce a desired adjustment of the mechanical field-attenuation mechanism, wherein, coaxially within the first rotor body and the second rotor body, a rotor shaft is torque-transmittingly coupled to the first rotor body and the second rotor body by the lever element, wherein the lever element is pivotably mounted on the rotor shaft.

2. The rotor according to claim 1, wherein at least one of
the lever element is rotatably mounted on a lever shaft relative to an annular lever carrier, which is positioned coaxially with respect to the rotor shaft, or
the lever element is mounted on a lever shaft which in turn is mounted in at least one of the rotor bodies.

3. The rotor according to claim 2, wherein the lever element is non-rotatably connected to the lever shaft and the lever shaft is rotatably mounted in a bearing bush of at least one of the lever carrier (64) or at least one of the first rotor body or the second rotor body.

4. The rotor according to claim 3, wherein the lever shaft is rotatably mounted in the bearing bush by a rolling bearing.

5. The rotor according to claim 1, wherein the lever element has a first lever disk with the first lever section and a second lever disk with the second lever section axially spaced from the first lever disk.

6. The rotor according to claim 1, wherein the rotor has a plurality of lever elements which are each arranged pivotably in a circumferentially distributed manner on the rotor shaft, wherein the lever elements each has a first lever disk and a second lever disk and two first lever disks are arranged in each case on a first lever shaft and two second lever disks are arranged in each case on a second lever shaft.

7. The rotor according to claim 5, wherein the first lever disk and the second lever disk are substantially identically shaped.

8. The rotor according to any one of the preceding claim 5, wherein at least one of the first lever disk or the second lever disk is punched from a sheet metal.

9. The rotor according to claim 1, wherein the first and second rotor bodies are each constructed in two parts, with an inner ring disk and an outer ring disk torque-transmittingly coupled to the inner ring disk, and wherein the first and second groups of permanent magnets are only arranged in the outer ring disk and the mechanical field-attenuation mechanism is only arranged at least one of in or on the inner ring disk.

10. An electric machine comprising a stator and a rotor separated from the stator by an air gap, wherein the rotor is configured according to claim 1.

11. The rotor according to claim 1, wherein the electric machine is disposed within a drivetrain of a hybrid or fully electrically driven motor vehicle.
